(19) United States
(12) Patent Application Publication
(10) Pub. No.: US 2011/0182414 A1
(43) Pub. Date: Jul. 28, 2011

(54) METHOD AND SYSTEM FOR DISPLAYING ENHANCED CALLER INFORMATION

(76) Inventors: Attray Hemant, Mumbai (IN); Rao Nageswara, Mumbai (IN); Jha Krishna, Mumbai (IN)

(21) Appl. No.: 12/695,175

(22) Filed: Jan. 28, 2010

(51) Int. Cl. H04M 1/56

(52) U.S. Cl. 379/142.06

(57) ABSTRACT

A method and system for rendering a set of enhanced caller information of a call on a Mobile Station. The method includes, retrieving one or more identifier corresponding to the call in response to a callee receiving the call from a caller. The method further includes, retrieving the set of enhanced caller information based on the one or more identifiers. Thereafter, the method renders the set of enhanced caller information on the MS of the callee.

### RELATED APPLICATION DETAILS

Benefit is claimed under 35 U.S.C. 119(a)-(d) to Foreign application Serial No. 172/MUM/2009 filed on 29 Jan., 2009, which is herein incorporated in its entirety by reference for all purposes.

### FIELD OF INVENTION

The invention generally relates to caller identification. More specifically, the invention relates to rendering a set of enhanced caller information in a telecommunication network.

### BACKGROUND OF THE INVENTION

Conventionally, a callee is presented with a set of caller information when the callee receives a call from a caller in a telecommunication network. The set of caller information may be stored in an address book in a mobile station (MS) used by the callee to receive the call. In such a case, a caller details screen is displayed to present the set of caller information to the callee on the MS. The caller details screen generally includes a phone number of the caller, a name of the caller and any graphics corresponding to the set of caller information stored in the address book. Alternatively, a set of caller information may not be stored in the address book of the MS used by the callee to receive the call. In such a case, the caller details screen is presented with one or more of a phone number of the caller and name of the caller. The name of the caller is added along with a Caller Line Identification (CLID) received by the MS when the callee receives the call on the MS.

In both the cases, the set of caller information is presented to enable the callee to handle the call from the caller. For example, the callee may reject the call based on a name of the caller. Alternatively, the callee could prepare for a conversation with the caller before accepting the call. Therefore, it is required that the callee be able to uniquely identify the caller based on the set of caller information presented.

There might be a scenario, where the callee is unable to uniquely identify the caller based on the set of caller information presented. In such a case, the callee is unable to handle the call efficiently. Therefore, the callee may require additional information to be included in the set of caller information of the caller to efficiently handle the call.

There is therefore a need for rendering a set of enhanced caller information which would enable the callee to uniquely identify the caller and handle the call efficiently.

### BRIEF DESCRIPTION OF THE FIGURES

The accompanying figures where like reference numerals refer to identical or functionally similar elements throughout the separate views and which together with the description below are incorporated in and form part of the provisional specification, serve to further illustrate various embodiments and to explain various principles and advantages all in accordance with the invention.

FIG. 1 illustrates a block diagram showing an environment in which various embodiments of the invention may function.

FIG. 2 illustrates a method for rendering a set of enhanced caller information in accordance with an embodiment of the invention.

FIG. 3 illustrates a method for retrieving a set of enhanced caller information in accordance with an embodiment of the invention.

FIG. 4 illustrates a system for rendering a set of enhanced caller information in accordance with an embodiment of the invention.

FIG. 5 illustrates an exemplary process flow diagram for rendering a set of enhanced caller information in accordance with an exemplary embodiment of the invention.

### DETAILED DESCRIPTION

As required, embodiments of the invention are disclosed herein; however, it is to be understood that the disclosed embodiments are merely exemplary of the invention, which can be embodied in various forms. Therefore, specific structural and functional details disclosed herein are not to be interpreted as limiting, but merely as a representative basis for teaching one skilled in the art to variously employ the invention in virtually any appropriately detailed structure. Further, the terms and phrases used herein are not intended to be limiting but rather to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

Various embodiments of the invention provide systems and methods for rendering a set of enhanced caller information on a Mobile Station (MS). A callee receives a call from a caller on the MS. The method includes, obtaining one or more identifiers corresponding to the call. The method further includes, retrieving the set of enhanced caller information based on the one or more identifiers corresponding to the call. The set of enhanced caller information may include one or more of a mapping information, a contextual information, a presence information and a status information. Thereafter, the method renders the set of enhanced caller information on the MS of the callee.

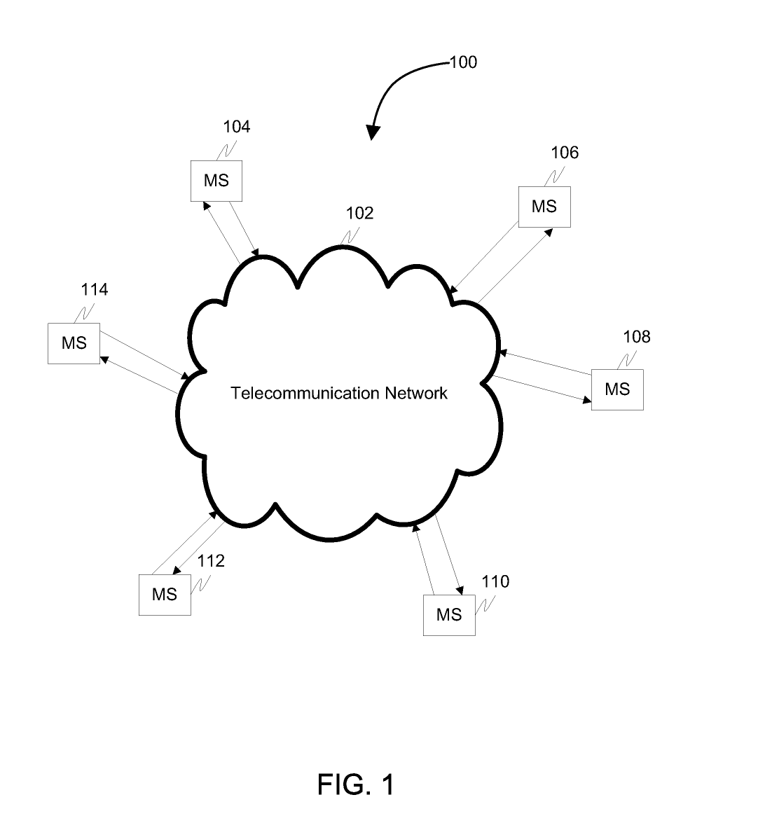

FIG. 1 illustrates a block diagram showing an environment 100 in which various embodiments of the invention may function. Environment 100 includes a telecommunication network 102 and a plurality of MSs. As depicted in FIG. 1, the plurality of MSs include a MS 104, a MS 106, a MS 108, a MS 110, a MS 112 and a MS 114. Examples of telecommunication network 102 may include, but are not limited to a Global System for Mobile (GSM) telecommunication network, a 3^{rd} Generation Partnership Project (3GPP) telecommunication network, a Wireless Interoperability Microwave Access (WiMAX) telecommunication network, a Code Division Multiple Access (CDMA) telecommunication network and a Public Switched Telephone Network (PSTN). Telecommunication network 102 may include one or more gateways and a plurality of Base Stations (not shown in figure) to enable communication between the MSs. Examples of a MS may include, but are not limited to a mobile phone, a personal digital assistant (PDA), and any hand-held devices using which a subscriber avails various communication services from a telecommunication service provider in telecommunication network 102. For example, a telecommunication service provider provides connectivity for the plurality of MS as depicted in FIG. 1 for communicating with each other using telecommunication network 102. Further, the telecommunication service provider may also provide one or more data transmission services enabling the plurality of MSs to access one or more data sources. Examples of a data transmission service may include, but need not be limited to a Short Message Service (SMS), an Unstructured Supplementary Service Data (USSD), General Packet Radio Service (GPRS), an Enhanced Data Rates for Global Systems for Mobile (EDGE) service and a 3^{rd} Generation (3G) communication service. The one or more data transmission services enable the plurality of MSs to access the one or more data sources without interrupting the call received from the caller.

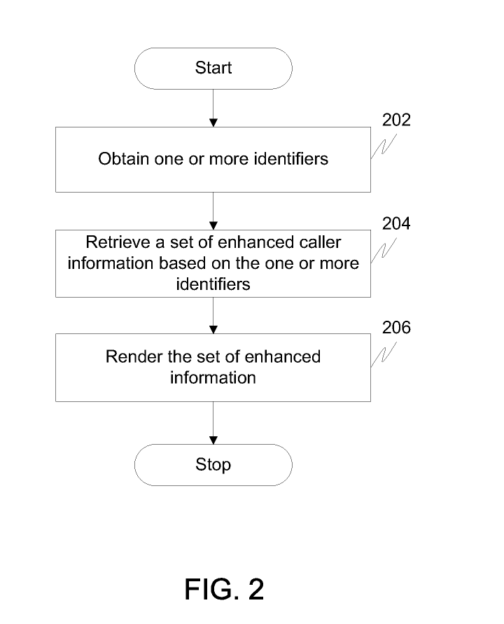

FIG. 2 illustrates a method for rendering a set of enhanced caller information in accordance with an embodiment of the invention. A callee receives a call on MS 104 from a caller using MS 106. In this case, the set of enhanced caller information corresponding to the caller is rendered on MS 104 in response to the call initiated by the caller using MS 106.

For rendering the set of enhanced caller information, one or more identifiers corresponding to the call are obtained at step 202. Examples of the one or more identifiers may include, but are not limited to, one or more phone numbers corresponding to the call, a Caller Line Identification (CLID) identifier and one or more names corresponding to the caller and the callee. The one or more identifiers may be obtained from a telecommunication service provider database as a process of establishing the communication between the callee and the caller. In an embodiment, a privileged access session is established with the telecommunication service provider database to obtain the one or more identifiers. Alternatively, the one or more identifiers may be obtained from MS 104 used by the callee. In this case, the one or more identifiers are obtained using one or more data transmission services supported by MS 104 such as Short Message Service (SMS), an Unstructured Supplementary Service Data (USSD), General Packet Radio Service (GPRS), an Enhanced Data Rates for Global Systems for Mobile (EDGE) service and a 3^{rd} Generation (3G) communication service. The one or more data transmission services supported by MS 104 enable the obtaining of the one or more identifiers in response to a call.

In response of retrieving the one or more identifiers, a set of enhanced caller information is retrieved at step 204. The set of enhanced caller information may include one or more of a mapping information, a contextual information, status information and presence information of the caller. The set of enhanced caller information may be retrieved from one or more data sources such as, a calendar on MS 106 of the caller, an activity log from a web site, a social networking site, a presence database, a blog entry and a contact database. In an embodiment, a contextual information is retrieved based on a CLID identifier of MS 106. The contextual information in this case may be a message describing a current activity of the caller retrieved from the calendar on MS 106 of the caller. The contextual information may also be a presence information retrieved from a presence database. The contextual information enables the callee to prepare for a conversation before accepting the call.

Mapping information may be a graphical representation of a degree of separation between the caller and the callee. Mapping information enables the callee to visualize the relationship (A direction relationship or an indirect relationship) between the caller and the callee. The mapping information may be retrieved from a social networking database such as Facebook™, LinkedIn™, Orkut™ and MySpace™ based on the one or more identifiers.

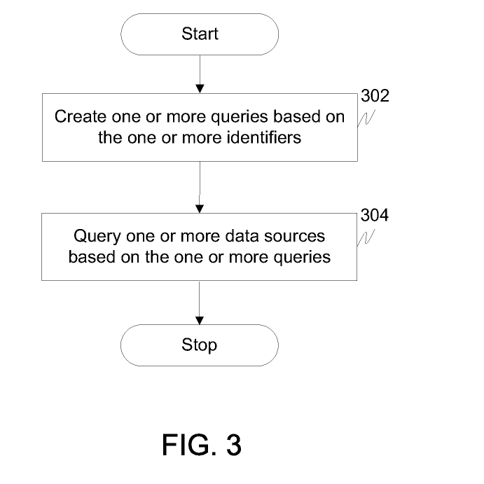

In an embodiment, the mapping information of the set of enhanced caller information is created from a contact database. The contact database is created using a plurality of contact lists retrieved from a plurality of MSs. For example, a contact database may be created using the plurality of contact lists retrieved from MS 104, MS 106, MS 108, MS 110, MS 112 and MS 114. Subsequently, the contact database can be used to create a mapping information between a plurality of users based on the plurality of contact lists in the contact database. For example, User A uses MS 104, User B uses MS 106, and User C uses MS 108. Contact lists from MS 104, MS 106 and MS 108 are retrieved and stored in a contact database. User A may have a contact information of User B stored in the contact list in MS 104. Similarly, User B may have a contact information of User C stored in the contact list in MS 106. Accordingly, a mapping information is created between User A and User C based on the contact lists from MS 104, MS 106 and MS 108 stored in the contact database in response to User A receiving a call from User C. The mapping information depicts a degree of separation between User A and User C. In this case, it is evident from the contact lists that User A knows User B and User B knows User C. Therefore, the degree of separation between User A and User C is one. Subsequently, the mapping information represents a relationship information between User A and User C using the degree of separation. The mapping information may be rendered to User A in response to User A receiving the call from User C. The step of retrieving the set of enhanced caller information is further explained in detail in conjunction with FIG. 3.

Thereafter, at step 206, the set of enhanced caller information is rendered on MS 104. In an embodiment, communication network 102 renders the set of enhanced caller information on MS 104 while establishing the call between MS 104 and MS 106. For example, the callee using MS 104 receives a call from the caller using MS 106. In such a case, the set of enhanced caller information including the mapping information is retrieved based on a phone number of the caller and is rendered on MS 104. Mapping information may be a graphical representation of a degree of separation between the caller and the callee. The mapping information reveals that the caller and the callee are related to each other through a user A. That is, the caller knows user A and the callee also knows user A. In an embodiment, the mapping information is represented as a nodal diagram depicting the degree of separation between the caller and the callee through user A. The nodal diagram is based on a degree of separation between the caller and the callee and is displayed on MS 104 used by the callee. In this case, the degree of separation of separation between the caller and the callee is ‘one-hop’ through user A. This would enable the callee receiving the call from the caller to identify the relationship with the caller and possibly a context of the call.

FIG. 3 illustrates a method for retrieving a set of enhanced caller information in accordance with an embodiment of the invention. The set of enhanced caller information may be retrieved using one or more queries. Accordingly, at step 302, the method creates one or more queries based on the one or more identifiers. Thereafter, at step 304, the set of enhanced caller information is retrieved by querying one or more data sources based on the one or more queries. For example, a query can be created based on a name and a phone number of a caller and the set of enhanced caller information may be retrieved based on the query. The query may be executed on one or more data sources. A data source of the one or more data sources may be a social networking database such as Facebook™, LinkedIn™, Orkut™ and MySpace™. Alternatively, a data source of the one or more data sources may be a contact database created from a plurality of contact lists retrieved from a plurality of MSs in the telecommunication network. The contact database can provide a mapping information as one of the information of the set of enhanced caller information based on the plurality of contact lists stored in the contact database. For example, a query is executed on the contact database to retrieve a mapping information as one of the information of the set of enhanced caller information. The query is formed using a phone number of a callee and a phone number of a caller to retrieve the mapping information between the caller and the callee. The mapping information represents a degree of separation between the caller and the callee.

The query for retrieving the set of enhanced caller information from the database is transmitted by MS 104 receiving a call. Accordingly, the query may be transmitted using one or more data transmission services supported by MS 104 such as a Short Message Service (SMS), an Unstructured Supplementary Service Data (USSD), General Packet Radio Service (GPRS), an Enhanced Data Rates for Global Systems for Mobile (EDGE) service and a 3^{rd} Generation (3G) communication service. The one or more data transmission services enable MS 104 to transmit the query simultaneously along with any other data transmission in response to the call.

In another embodiment, telecommunication network 102 retrieves the set of enhanced caller information from one or more data sources in response to the callee using MS 104 receiving the call from the caller using MS 106. Telecommunication network 102 uses the one or more identifiers corresponding to the call to retrieve the set of enhanced caller information. Alternatively, Telecommunication network 102 may query the one or more data sources based on one or more queries created using the one or more identifiers. In an exemplary embodiment, a data source of the one or more data sources may be a social networking database such as Facebook™, LinkedIn™, Orkut™ and MySpace™. In another exemplary embodiment, a data source of the one or more data sources may be a contact database created using a plurality of contact lists retrieved from a plurality of MSs in telecommunication network 102. In such a case, a mapping information can be retrieved from the contact database. The mapping information depicts a relationship between the caller and the callee.

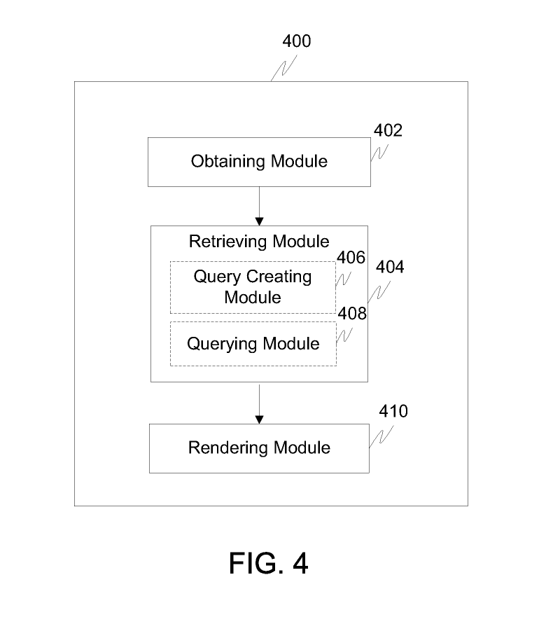

FIG. 4 illustrates a system 400 for rendering a set of enhanced caller information in accordance with an embodiment of the invention. System 400 includes an Obtaining Module 402, in order to render the set of enhanced caller information, Obtaining Module 402 obtains one or more identifiers based on a call received by a callee from a caller. For example, Obtaining Module 402 obtains a phone number and a name of the caller in response to the call. The phone number and the name of the caller may be retrieved as a CLID identifier.

The one or more identifiers may be obtained from a MS used by the callee using one or more data transmission services supported by the MS. The one or more data transmission services such as Short Message Service (SMS), an Unstructured Supplementary Service Data (USSD), General Packet Radio Service (GPRS), an Enhanced Data Rates for Global Systems for Mobile (EDGE) service and a 3^{rd} Generation (3G) communication service, enables Obtaining Module 402 to obtain the one or more identifiers without interrupting the call. For example, when a callee receives a call on MS 104 from a caller using MS 106, Obtaining Module 402 obtains the one or more identifiers from MS 104 using an USSD message. Alternatively, the one or more identifiers may be obtained by Obtaining Module 402 using a privileged access session established with a telecommunication service provider database. For example, when a callee using MS 104 receives a call from a caller using MS 106, Obtaining Module 402 logs into the telecommunication service provider database, thus establishing a privileged session with the telecommunication service provider database. Further, Obtaining Module 402 obtains a CLID identifier based on the call from the telecommunication service provider database. The Obtaining Module 402 may utilize existing data transmission services to log into the telecommunication service provider database.

Once Obtaining Module 402 obtains the one or more identifiers, a Retrieving Module 404 retrieves a set of enhanced caller information based on the one or more identifiers. The set of enhanced caller information may be retrieved from one or more data sources. For example, an information of the set of enhanced caller information may be a contextual information of a caller such as current activity of the caller and current location of the caller. The contextual information of a caller may be retrieved from the one or more data sources such as a calendar and a GPS tracker in a MS of the caller. In an embodiment, Retrieving Module 404 is located in a telecommunication service provider server. Retrieving Module 404 retrieves the contextual information using a USSD service based on a phone number of the caller obtained by Obtaining Module 402. Retrieving Module 404 identifies the MS corresponding to the phone number of the caller. Subsequently, Retrieving Module 404 accesses the calendar and the GPS tracker in the MS to retrieve the current activity and the current location of the caller.

Additionally, the set of enhanced caller information may include a status information such as a status message depicting a presence information of the caller and a current activity of the caller. Conventionally, the status message depicting the presence information of the caller and the current activity of the caller may be located in one or more of a social networking website, a blogging service website, an E-Mail service website, a personal website and any web based service, enabling users to collaboratively share personal experiences. Caller may update the status message in a social networking website and the status message in the social networking site may be “On vacation”. The status information may enable the callee to prepare for a conversation with the caller before accepting the call. Based on this information, the callee may enquire regarding the current status, in this case, a vacation. Accordingly, Retrieving Module 404, logs into the social networking website based on one or more login credentials of the caller and retrieves a latest updated status message corresponding to a name of the caller. The latest updated status message of the caller establishes the presence information and the current activity of the caller.

In an embodiment, the set of enhanced caller information retrieved by Retrieving Module 404 may include a mapping information. Mapping information may be a graphical representation of a relationship between a caller and a callee. The graphical representation may be for example, a nodal diagram and a line diagram. The mapping information may be based on the degrees of separation between the caller and the callee. In an embodiment, the mapping information is retrieved from a social network site. In such a case, Retrieving Module 404 logs into the social networking site using one or more login credentials of the callee obtained by Obtaining Module 402. The social networking site provides the mapping information based on the names of the caller and the callee. The mapping information may be a list of contacts shared by the caller and the callee in the social networking site. This enables the callee to establish a relationship with the caller while receiving the call.

In another embodiment, the mapping information is created based on the one or more identifiers obtained by Obtaining Module 402. In this case, one of the one or more data sources is a contact database created from a plurality of contact lists retrieved from a plurality of MSs. The contact database may be provided by the telecommunication service provider. In such a case, Retrieving Module 404 analyzes the contact database and retrieves the mapping information by establishing a privileged access session with the contact database provided by the telecommunication service provider. Alternatively, the contact database may be created and maintained by Retrieving Module 404. For example, a contact database can be created using contact lists retrieved from MS 104, MS 106, and MS 108. In this case, Retrieving Module 404 logs into the contact database and analyzes the contact database and creates a mapping between a caller using MS 104 establishing a call with a callee using MS 108, in response to the call. The mapping may be created based on the fact that, a contact information of a User A is stored in the contact lists retrieved from MS 104 and MS 108. This would establish a relationship information which may be depicted as “the caller knows User A” and “the callee knows User A”. The relationship information enables the callee to uniquely identify the caller prior to the call.

There may be scenario where the mapping information may be retrieved from one or more social networking databases such as Facebook™, LinkedIn™, Orkut™ and MySpace™. The mapping information may be retrieved by querying the one or more social networking databases based on one or more queries created from the one or more identifiers. The mapping information may also be retrieved using one or more applications such as an Application Programmable Interface (API), a widget, and a RSS feed reader.

In an embodiment, Retrieving Module 404 includes a Query Creating Module 406 and a Querying Module 408. In such a case, Query Creating Module 406 creates one or more queries based on one or more identifiers obtained by Obtaining Module 402. Subsequently, Querying Module 408 queries one or more data sources for retrieving the set of enhanced caller information based on the one or more queries created by Query Creating Module 406. For example, a caller using MS 104 initiates a call to a callee using MS 106. In response to Obtaining Module 402 obtaining phone numbers of the caller and the callee, Query Creating Module 406 creates a query based on the phone numbers. Subsequently, Querying Module 408 queries a contact database created using contact lists retrieved from MS 104, MS 106, MS 108, MS 110, MS 112 and MS 114. A mapping information depicting a degree of separation between the caller and the callee is retrieved based on the query. In this case, the mapping information depicting the relationship between the caller and the callee is based on an information that a contact detail of User A is stored in the contact list of MS 104 and MS 106. This information establishes a relationship between the caller and the callee which may be represented as “Caller knows User A” and “Callee knows User A”. Alternatively, the relationship may be represented as “Mutual Friend, user A”. In another case, Query Creating Module 406 may create a query to be executed on a social networking database. In this case, the query is created based on names of the caller and the callee. Subsequently, Querying Module 408 queries the social networking database such as Facebook™, LinkedIn™, Orkut™ and MySpace™ to retrieve the set of enhanced caller information which may include a mapping information. The mapping information may be based on a list of common friends shared by the caller and the callee.

Querying Module 408 may query the one or more data sources using one or more data transmission services such as a Short Messaging Service (SMS), an Unstructured Supplementary Service Data (USSD) service, a General Packet Radio Service (GPRS), an Enhanced Data Rates for Global Systems for Mobile (EDGE) service and a 3^{rd} Generation (3G) communication service.

Thereafter, a Rendering Module 410 renders the set of enhanced caller information to a callee on a MS receiving a call from a caller. For example, a mapping information is rendered to a callee. In such a case, the Rendering Module 410 embeds the mapping information along with an advanced CLID identifier. In an embodiment, the set of enhanced caller information is transferred to a MS of a callee receiving a call from a caller. In such a case, the set of enhanced caller information may be transmitted using one or more data transmission services supported by the MS such as a Short Messaging Service (SMS), an Unstructured Supplementary Service Data (USSD) service, a General Packet Radio Service (GPRS), an Enhanced Data Rates for Global Systems for Mobile (EDGE) service and a 3^{rd} Generation (3G) communication service. For example, a nodal diagram representing the mapping information between a caller and a callee may be transmitted using an EDGE service. This would enable the callee to receive the nodal diagram without interrupting the call. There may be a scenario when the set of enhanced caller information retrieved by Retrieving Module 404 is not compatible to be rendered in the MS. In such a case, Rendering Module 410 converts the set of enhanced caller information into a set of converted enhanced caller information compatible to be rendered in the MS.

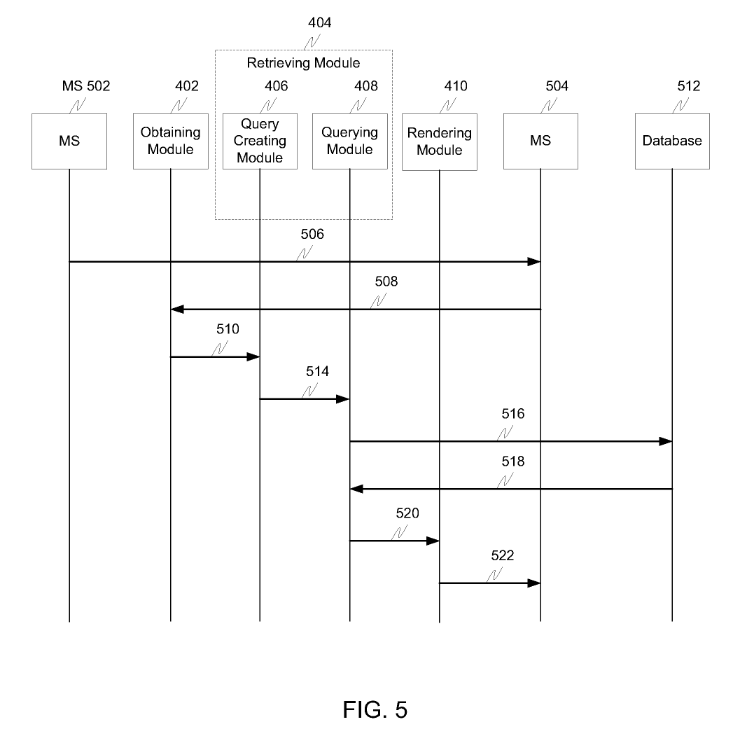

FIG. 5 illustrates an exemplary process flow for rendering a set of enhanced caller information in accordance with an exemplary embodiment of the invention. A caller initiates a call using MS 502 and a callee receives the call using MS 504 at step 506. Thereafter, Obtaining Module 402 obtains phone numbers of MS 502 and MS 504 at step 508. On receiving the call, MS 504 sends a request to Obtaining Module 402 requesting the set of enhanced caller information. The phone numbers are send along with the request and Obtaining Module 402 obtains the phone numbers as a SMS. This ensures that the call initiated is not interrupted during the obtaining of the phone numbers. The set of enhanced caller information is retrieved by Retrieving Module 404. In this case, Retrieving Module 404 includes Query Creating Module 406 and Querying Module 408. Accordingly, Obtaining Module 402 transmits the phone numbers to Query Creating Module 406 at step 510. Subsequently, Query Creating Module 406 creates a query based on the phone numbers. The query is created based on a data source that Querying Module 408 queries to retrieve a set of enhanced caller information, in this case a database 512. Thereafter, Query Creating Module 406 sends the query to Querying Module 408 at step 514. Accordingly, Querying Module 408 queries database 512 at step 516 and retrieves a mapping information between the caller and the callee based on the query at step 518. Database 512 includes a set of contact lists retrieved from a plurality of MSs. The set of contact lists is used to create the mapping information.

The mapping information illustrates a degree of separation between the caller and the callee. Hence, the mapping information reveals a relationship between the caller and the callee. For example, database 512 is a contact database which includes a set of contact lists retrieved from MS 502, MS 504 and a third MS (not shown in figure) used by a user A. Further, a contact information of the user A is stored in a contact list of MS 502 and MS 504. Hence, it can be concluded that the caller knows user A and callee knows user A as well. In such a case, based on the query created by Query Creating Module 406, a mapping information is retrieved by the Querying Module 408 from database 512 based on the query. In this case the mapping information is “the caller knows user A and the callee knows user A”. Alternatively, mapping information may also be represented based on a degree of separation and the number of ‘hops’ between the caller and the callee such as, “One mutual friend—user A”. This enables the callee to uniquely identify the caller based on the mapping information.

At step 520, Querying Module 408 transmits the mapping information to Rendering Module 410. Rendering Module 410 converts the mapping information received into a node diagram representing a relationship between the caller and the callee based on the mapping information, which is transmitted using a GPRS service to MS 504 at step 522. Alternatively, Rendering Module 410 may embed the mapping information with one or more advanced CLID identifiers and transmit the one or more advanced CLID identifiers to MS 504. Examples of an advanced CLID identifier may include a sub-address field and any identifier transmitted to an MS receiving a call during initialization of the call. Thereafter, MS 504 displays the diagram as caller information to the callee. The callee handles the call accordingly based on this information. For example, callee may decide to accept the call based on the mapping information. Further, the mapping information may also allow the callee to prepare a conversation with the caller. In this example, the callee may enquire about user A based on the mapping information “the caller knows user A and the callee knows user A”. Hence, the callee is able to prepare for the call before accepting the call using the mapping information.

Various embodiments of the invention provide methods and systems for rendering a set of enhanced caller information on a MS. The set of enhanced caller information may include a contextual information of a caller. This enables a callee receiving a call from the caller to prepare for a conversation with the caller and also identify the caller uniquely before accepting the call. Alternatively, the set of enhanced caller information may be a mapping information based on a relationship between the caller and the callee. The mapping information enables the callee to uniquely identify the caller based on the relationship and handle the call efficiently.

Those skilled in the art will realize that the above-recognized advantages and other advantages described herein are merely exemplary and are not meant to be a complete rendering of all of the advantages of the various embodiments of the invention.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims.

What we claim:

1. A method for rendering a set of enhanced caller information in a telecommunication network, the method comprising:
obtaining at least one identifier corresponding to a call;
retrieving the set of enhanced caller information based on the at least one identifier, wherein the set of enhanced caller information comprises at least one of a contextual information and a mapping information; and
rendering the set of enhanced information to a callee receiving the call from a caller.

2. The method of claim 1, wherein the at least one identifier comprises a Caller Line Identification (CLID) identifier.

3. The method of claim 1, wherein the mapping information comprises at least one of a degree of separation information between the caller and the callee and a relationship information between the caller and the callee.

4. The method of claim 1, wherein the retrieving further comprises:
creating at least one query based on the at least one identifier; and
querying at least one data source in response of creating the at least one query.

5. The method of claim 4, wherein a data source of the at least one data source is one of a social networking database, a blog entry, a presence database and a contact database, wherein the contact database is created from a plurality of contact lists obtained from a plurality of mobile stations (MSs) in a telecommunication network.

6. The method of claim 5, wherein the retrieving further comprises:
developing the mapping information between the caller and the callee based on the contact database.

7. The method of claim 1, wherein the set of enhanced caller information is rendered in response to the call received on a Mobile Station (MS) of the callee from the caller.

8. A system for rendering a set of enhanced caller information in a telecommunication network, the system comprising:
an obtaining module configured to obtain at least one identifier corresponding to a call;
a retrieving module configured to retrieve the set of enhanced caller information based on the at least one identifier, wherein the set of enhanced caller information comprises at least one of a contextual information and a mapping information; and
a rendering module configured to render the set of enhanced information to a callee receiving the call from a caller.

9. The system of claim 8, wherein the obtaining module obtains the at least one identifier from a Mobile Station (MS) used by the callee to receive the call.

10. The system of claim 8, wherein the obtaining module obtains the at least one identifier from a telecommunication service provider.

11. The system of claim 8, wherein the retrieving module retrieves the set of enhanced caller information using at least one of a Simple Messaging Service (SMS), a Unstructured Supplementary Service Data (USSD), a General Packet Radio Service (GPRS), an Enhanced Data Rates for Global Systems for Mobile (EDGE) service and a 3^{rd} Generation (3G) communication service based on the at least one identifier.

12. The system of claim 8, wherein the retrieving module further comprises:
a query creating module configured to create at least one query based on the at least one identifier; and
a querying module configured to query at least one data source in response of creating the at least one query, wherein a data source of the at least one data source is one of a social networking database, a blog entry, a presence database and a contact database, wherein the contact database is created from a plurality of contact lists obtained from a plurality of MSs in a telecommunication network.

13. The system of claim 12, wherein the retrieving module further comprises a mapping information developing module configured to develop the mapping information between the caller and the callee based on the contact database.

14. The system of claim 13, wherein the rendering module further comprises a nodal diagram rendering module configured to render a nodal diagram representing the mapping information between the caller and the callee.

15. The system of claim 8, wherein the retrieving module is located at a server of the telecommunication service provider.

16. The system of claim 8, wherein the retrieving module is located in the MS used by the callee to receive the call from the caller.
